(19) United States
(12) Patent Application Publication
(10) Pub. No.: US 2020/0257157 A1
(43) Pub. Date: Aug. 13, 2020

(54) DISPLAY MODULE AND DISPLAY APPARATUS

(71) Applicant: HKC Corporattion Limited, Shenzhen (CN)

(72) Inventor: CHUNG-KUANG CHIEN, Chongqing (CN)

(73) Assignee: HKC Corporattion Limited, Shenzhen (CN)

(21) Appl. No.: 16/461,802

(22) PCT Filed: May 10, 2017
(86) PCT No.: PCT/CN2017/083789

§ 371 Date: May 17, 2019

(30) Foreign Application Priority Data
Dec. 29, 2016 (CN) 2016112480244

(51) Int. Cl. G02F 1/1333; G02F 1/1339; G02F 1/1335

(52) U.S. Cl. CPC G02F 1/133308; G02F 1/133512; G02F 1/1339

(57) ABSTRACT

The present application discloses a display module and a display apparatus. The display module includes a display panel and a module frame, a lateral side of the display panel is connected to the module flame through use of a light shading adhesive body. The lateral side of the display panel is connected to the periphery of the module frame through use of the light shading adhesive body, to prevent the lateral side of the display panel from leaking light.

This application claims priority to Chinese Patent Application No. CN 2016112480244, filed with the Chinese Patent Office on Dec. 19, 2016 and entitled “DISPLAY MODULE AND DISPLAY APPARATUS”, which is incorporated herein by reference in its entirety.

### TECHNICAL FIELD

The present application relates to the technical field of displays, and more particularly to a display module and a display apparatus.

### BACKGROUND

The description herein merely provides background information related to the present application d does not necessarily constitute prior art.

Display apparatuses have numerous advantages, such as a thin body, power saving, no radiation, etc. and are widely used. Most display apparatuses in the market are backlight display apparatuses, each including a display panel and a backlight module. Working principle of the display panel is that liquid crystals are put in two parallel substrates, and a driving voltage is applied to the two substrates to control a rotational direction of the liquid crystals, to refract light rays of the backlight module to generate a picture.

Thin film transistor liquid crystal display apparatuses (TFT-LCD apparatuses) currently maintain a leading status in the display field because of low power consumption, excellent picture quality, high production yield, and other properties. Similarly, the If T-LCD apparatus includes a display panel and a backlight module. The display panel includes a color filter substrate (CF substrate), a thin film transistor substrate (TFT substrate) and transparent electrodes on relative inner sides of the above substrates. A layer of liquid crystals (LC) is positioned between two substrates. The display panel changes a polarized state of light by controlling direction of the LC through an electric field, for penetration and obstruction of a light path via a polarized plate to display.

In a four-sided borderless display panel in existing development or mass production, lateral sides of the display panel are affected by backlight so that some light rays still can be observed by human eyes through reflection by the lateral sides and need to be processed.

### SUMMARY

The purpose of the present application is to provide a display module for solving light leakage on a lateral side of a display panel.

In addition, the present application further provides a display apparatus using the display panel.

The purpose of the present application is achieved by the following technical solution.

A display module includes a display panel and a module frame, a lateral side of the display panel is connected to the module frame via a light shading adhesive body.

Optionally, the display panel includes a first substrate and a second substrate arranged opposite to each other. An outer surface edge of the first substrate is connected to the module frame via the light shading adhesive body.

Optionally, the light shading adhesive body is a black sealant.

Optionally; a light shading body is positioned between an inner surface edge of the first substrate and the inner surface edge of the second substrate, the light shading body is connected to the black sealant.

Optionally, the light shading body is a black photoresistance spacer (BPS).

Optionally, a spacer is positioned between an inner surface of the first substrate and an inner surface of the second substrate, the spacer is made from a same material as the light shading body.

Optionally, a black matrix (BM) is disposed on an outer surface edge of the second substrate, the light shading body is arranged in correspondence with the BM.

Optionally, the light shading body is disposed on the lateral side of the BM, the light shading body is connected to the light shading adhesive body and the module frame.

Optionally, the light shading body is disposed on the lateral side of the BM, the light shading both is connected to the light shading adhesive body or the module frame.

Optionally, the display panel of the present application may be a curved panel.

Optionally, the light shading adhesive body is liquid glue.

Optionally, the light shading adhesive body is the black sealant, the BPS is positioned between the inner surface edge of the first substrate and the inner surface edge of the second substrate. The BPS is connected to the black sealant. The BM is disposed on the outer surface edge of the second substrate. The BPS is arranged in correspondence with the BM. The spacer is positioned between the inner surface of the first substrate and the inner surface of the second substrate. The spacer is made from a same material as the BPS.

Optionally, the optical density value is greater than or equal to 4 after the black sealant is overlapped with the BPS.

Optionally, the module frame is a module iron frame, a module plastic framed and a module steel frame.

Optionally, the first substrate and the second substrate are made of glass and plastic.

The application also discloses a display module, inch ding a display panel and a module frame; a lateral side of the display panel is connected to the module frame through use of a light shading adhesive body; the display module is coupled to a control circuit board; the display panel includes a first substrate and a second substrate arranged opposite to each other; and an outer surface edge of the first substrate is connected to the module frame through use of a light shading adhesive body; and the light shading adhesive body is a black sealant; a light shading body is positioned between an inner surface edge of the first substrate and an inner surface edge of the second substrate; and the light shading body is connected to the black sealant; and the light shading body is a black photoresistance spacer (BPS); a spacer is positioned between an inner surface of the first substrate and an inner surface of the second substrate; and the spacer is made from a same material as the light shading body; a black matrix (BM) is disposed on an outer surface edge of the second substrate; and the light shading, body is arranged in correspondence with the BM.

According to another aspect of the present application, the present application also discloses a display apparatus includes the any of the above display modules and, a control circuit board. The display module is coupled to the control circuit board.

Compared with the prior art, the technical effects of the present application are that:

The lateral side of the display panel is connected to the periphery of the module frame via the light shading adhesive body, to prevent the display panel from leaking light on the lateral side. The light shading adhesive body has good viscosity, can firmly adhere two different media such as the module frame and the display panel on both sides, is resistant to environmental changes, is not easy to generate bubbles, can be controlled in thickness by adjusting the amount of sealant, and is suitable for the four-sided borderless display panel.

### BRIEF DESCRIPTION OF DRAWINGS

FIG. 1 is a partial schematic diagram of a display panel according to an embodiment of the present application.

FIG. 2 is a partial schematic diagram of a display module according to an embodiment of the present application.

FIG. 3 is another partial schematic diagram of a display module according to an embodiment of the present application.

FIG. 4 is a further partial schematic diagram of a display module according to an embodiment of the present application.

FIG. 5 is another partial schematic diagram of a display panel according to an embodiment of the present application.

FIG. 6 is a partial schematic diagram of a display module in combination with FIG. 5 according to an embodiment of the present application.

FIG. 7 is a further partial schematic diagram of a display panel according to an embodiment of the present application.

FIG. 8 is a partial schematic diagram of a display module in combination with FIG. 7 according to an embodiment of the present application.

FIG. 9 is another partial schematic diagram of a display module in combination with FIG. 7 according to an embodiment of the present application.

FIG. 10 is a schematic diagram of a display apparatus according to an embodiment the present application.

### DETAILED DESCRIPTION

Specific structure and function details disclosed herein are only representative and are used for the purpose of describing exemplary embodiments of the present application. However, the present application may be specifically achieved in many alternative forms and shall not be interpreted to be only limited to the embodiments described herein.

It should be understood in the description of the present application that terms such as “central”, “horizontal”, “upper”, “lower”, “left”, “right”, “vertical”, “horizontal”, “top”, “bottom”, “inner”, “outer”, etc. indicate direction or position relationships shown based on the drawings, and are only intended to facilitate the description of the present application and the simplification of the description rather than to indicate or imply that the indicated device or element must have a specific direction or constructed and operated in a specific direction, and therefore, shall not be understood as a limitation to the present application. In addition, the terms such as “first” and “second” are only used for the purpose of description, rather than being understood to indicate or imply relative importance or hint the number of indicated technical features. Thus, the feature limited by “first” and “second” can explicitly or impliedly include one or more features. In the description of the present application, the meaning of “a plurality of” is two or more unless otherwise specified. In addition, the term “comprise” and any variant are intended to cover non-exclusive inclusion.

It should be noted in the description of the present application that, unless otherwise specifically regulated and defined, terms such as “installation,” “bonded,” and “bonding” shall be understood in broad sense, and for example, may refer to fixed bonding or detachable bonding or integral bonding; may refer to mechanical bonding or electrical bonding; and may refer to direct bonding or indirect bonding through an intermediate medium or inner communication of two elements. For those of ordinary skill in the art, the meanings of the above terms in the present application may be understood according to concrete conditions.

The terms used herein are intended to merely describe concrete embodiments, not to limit the exemplary embodiments. Unless otherwise noted clearly in the context, singular forms “one” and “single” used herein are also intended to comprise plurals. It should also be understood that the terms “comprise” and/or “include” used herein specify the existence of stated features, integers, steps, operation, units and/or assemblies, not excluding the existence or addition of one or more other features, integers, steps, operation, units, assemblies and/or combinations of these.

The present application will be described in detail below in combination with the drawings and embodiments.

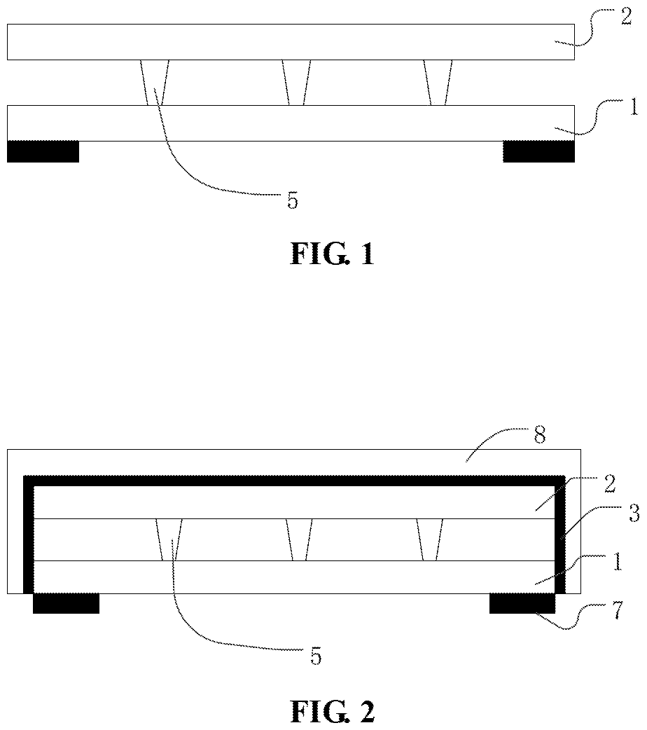

A display module and a display apparatus in embodiments of the present application are described below by reference to FIG. 1 to FIG. 9.

As shown in FIG. I to FIG. 2, the display module 10 in embodiments of FIG. 1 and FIG. 2 includes a display panel 11. In the display panel 11, especially four-sided borderless TFT-LCD products, since a T side faces forwards, a front side may shield surrounding metal wires through a manufacturing process of coating or printing a BM, to avoid visual user interference. But lateral sides of the panel are affected by backlight, so that some light rays still can be observed by human eyes through reflection by the lateral sides. The display module 10 can be formed by adding a module frame 8 outside a liquid crystal panel, so as to solve light leakage on the lateral sides. A black double-sided tape 3 is adhered around the module frame 8, and the module frame 8 is adhered and fixed to the lateral sides of the liquid crystal panel via the black double-sided tape 3, to prevent light leakage on the lateral sides. The module frame 8 of the liquid crystal panel can also be connected to an outer lateral side of a color filter substrate via the black double-sided tape 3, to strengthen the fixation. However, as products are increasingly thinned, the black double-sided tape 3 will be required to become thinner, and both sides of the black double-sided tape 3 need to adhere to two different media, including the module frame 8 such as an iron frame and an outer surface of the color filter substrate 2 such as glass, so that the requirements for adhesive force are high, and the black double-sided tape 3 has problems of being easy to have bubbles and not resistant to environmental changes.

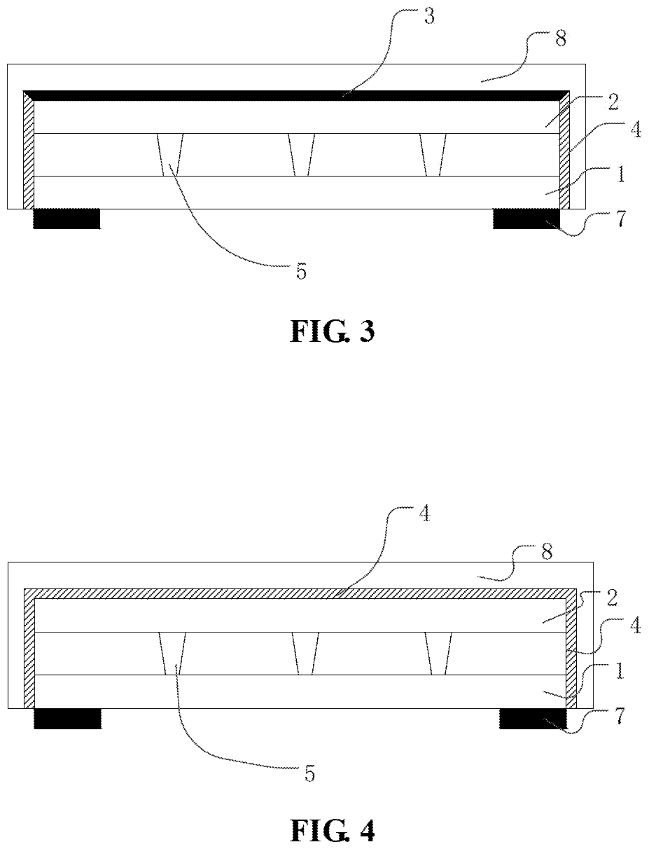

As shown in FIG. 3, the display module 10 in an embodiment of FIG. 3 includes a display panel 11 and a module frame 8. A lateral side of the display panel 11 is connected to the module frame 8 through use of a light shading adhesive body 4. The lateral side of the display panel 11 is connected to the periphery of the module frame 8 through use of the light shading adhesive body 4, to prevent the lateral side of the display panel 11 from leaking light. The light shading adhesive body 4 has good viscosity, can firmly adhere two different media such as the module frame 8 and the display panel 11 on both sides, is resistant to environmental changes, is not easy to generate bubbles, can be controlled in thickness by adjusting the amount of sealant, and is especially suitable for the four-sided borderless display panel 11. The light shading adhesive body 4 is liquid glue.

As shown in FIG. 4, the display module 10 in an embodiment of FIG. 4 includes a display panel 11 and a module frame 8. A lateral side of the display panel 11 is connected to the module frame 8 through use of a light shading adhesive body 4. The light shading adhesive body 4 has good viscosity, can firmly adhere two different media such as the module frame 8 and the display panel 11 on both sides, is resistant to environmental changes, is not easy to generate bubbles, can be controlled in thickness by adjusting the amount of sealant. The display panel 11 includes a first substrate 13 and a second substrate 14 arranged opposite to each other. An outer surface edge of the first substrate 13 is connected to the module frame 8 through use of the light shading adhesive body 4. The first substrate13 and the module frame 8 are connected more firmly trough connection of the light shading adhesive bod 4. In the display panel 11, especially four-sided borderless TFT-LCD products, the first substrate 13 is a color filter substrate 2, and the second substrate 14 is a TFT substrate 1. Since the TFT substrate 1 faces forwards and is followed by the color filter substrate 2, the outer surface edge of the color filter substrate 2 is connected to the module frame 8 through use of the light shading adhesive body 4, so that the liquid crystal panel can be better fixed, and the light shading adhesive body 4 has an adhesion better than that of a double-sided tape. Certainly, in the above embodiment, the first substrate 13 can also be the TFT substrate 1, while the second substrate 14 is the color filter substrate 2.

As shown in FIG. 3 and FIG. 4, the display module 10 in embodiments of FIG. 3 and FIG. 4 includes a display panel 11 and a module frame 8. A lateral side of the display panel 11 is connected to the module frame 8 through use of a light shading adhesive body 4. The lateral side of the display panel 11 is connected to the periphery of the module frame 8 through use of the light shading adhesive body 4, to prevent the lateral side of the display panel 11 from leaking light. The light shading adhesive body 4 has good viscosity, can firmly adhere two different media such as the module frame 8 and the display panel 11 on both sides, is resistant to environmental changes, is not easy to generate bubbles, can be controlled in thickness by adjusting the amount of sealant, and is especially suitable for the four-sided borderless display panel 11. The display panel 11 includes a first substrate 13 and a second substrate 14 arranged opposite to each other. An outer surface edge of the first substrate 13 can be connected to the module frame 8 via a black double-sided tape 3 and can also be connected via other adhesive materials. Optionally, the outer surface edge of the first substrate 13 is connected to the module frame 8 via the light shading adhesive body 4. The light shading adhesive body 4 is liquid glue. The light shading adhesive body 4 is optionally a black sealant. The black sealant has advantages of good viscosity, resistance to environmental changes, and the like, and can be controlled in thickness by adjusting the amount of sealant.

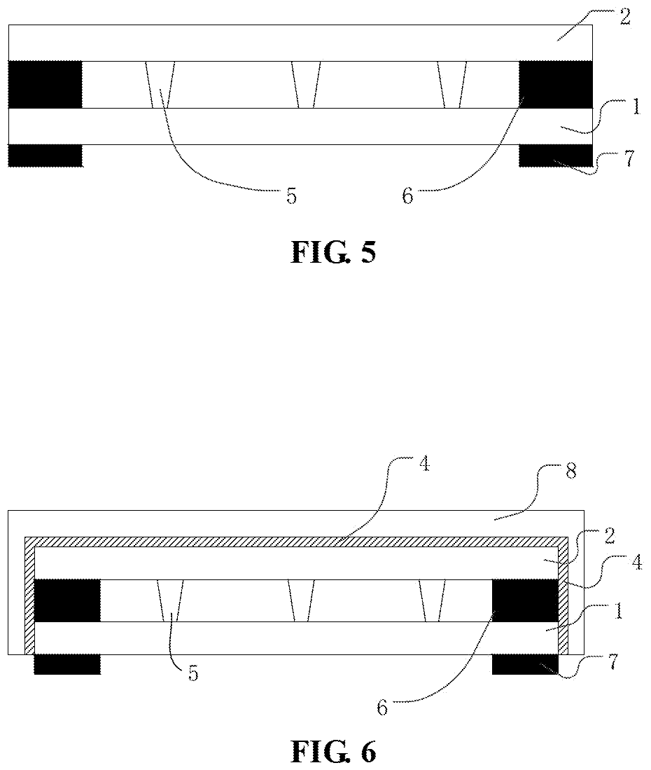

As shown in FIG. 5 and FIG. 6, the display module 10 in embodiments of FIG. 5 and FIG. 6 includes a display panel 11 and a module frame S. A lateral side of the display panel 11 is connected to the module frame 8 through use of a light shading adhesive body 4. The light shading adhesive body 4 is a black sealant. The black sealant has advantages of good viscosity, resistance to environmental changes, and the like, and can be controlled in thickness by adjusting the amount of sealant. A light shading body 15 is positioned between an inner surface edge, of the first substrate 13 and the inner surface edge of the second substrate 14. The light shading body 15 is connected to the black sealant. The black sealant has an OD value capable of reaching 2 in the case of 3 μm due to consideration of sealing performance, and cannot meet the requirement of completely shading light rays (OD≥4). A circle of light shading body 15 is positioned between the inner surface edge of the first substrate 13 and the inner surface edge of the second substrate 14, namely, around the display panel 11. The light shading body 15 is connected to the black sealant. The OD value after the light shading body 15 is overlapped with the black sealant reaches 4, to completely solve light leakage on the lateral side.

The light shading body 15 is a black photoresistance spacer (BPS) 6. The BPS 6 has a light shading effect, has the OD value capable of reaching about 2 dues to consideration of characteristics of a spacer 5, and has the OD value capable of reaching 4 after overlapping with the black sealant, to completely solve light leakage on die lateral side. Meanwhile, the BPS 6 and the spacer 5 can be done in the same manufacturing process without additional devices and manufacturing processes. Certainly, the light shading body 15 can also be made of other materials. The spacer 5 is positioned between an inner surface edge of the first substrate 13 and an inner surface of the second substrate 14. The spacer 5 can also be a photo spacer (PS) other spacers and the like.

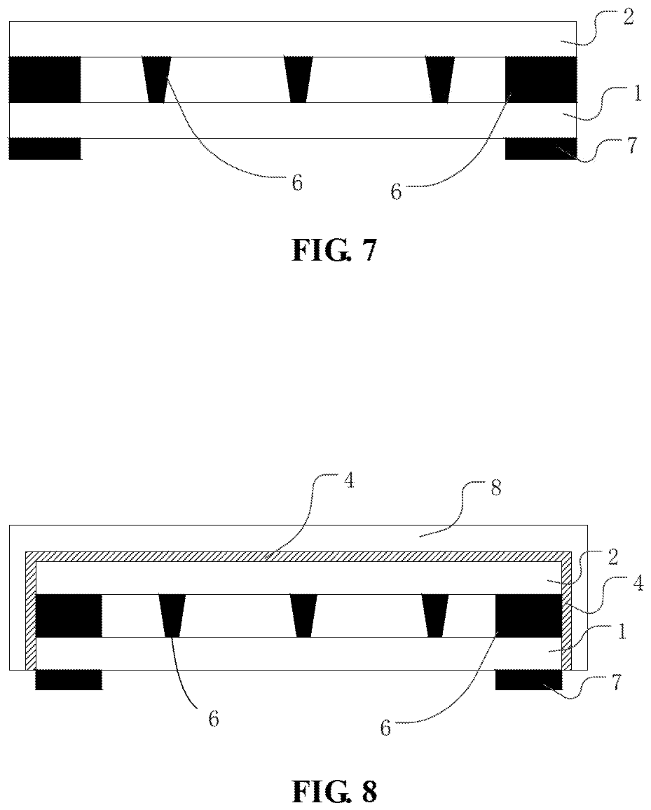

As Shown in FIG. 7 and FIG. 8, the display module 10 in embodiments of FIG. 7 and FIG. 8 includes a display panel 11 and a module frame 8. A lateral side of the display panel 11 is connected to the module frame 8 via a light shading adhesive body 4. The light shading adhesive. body 4 is a black sealant. The black sealant has advantages of good viscosity, resistance to environmental changes, and the like, and can be controlled in thickness by adjusting the amount of sealant. A light shading body 15 is positioned between an inner surface edge of the first substrate 13 and an inner surface edge of the second substrate 14. The light shading body 15 is connected to the black sealant. The black sealant has an OD value capable of reaching 2 in the case of 3 μm due to consideration of sealing performance, and cannot meet the requirement of completely shading light rays (OD≥4). A circle of light shading body is, positioned between the inner surface edge of the first substrate 13 and the inner surface edge of the second substrate 14, namely, around the display panel 11. The light shading body 15 is connected to the black sealant. The OD value after the light shading body 15 is overlapped with the black sealant reaches 4, to completely solve light leakage on the lateral side.

The light shading body 15 is a BPS 6. The BPS 6 has a light shading effect, has the OD value capable of reaching about 2 dues to consideration of characteristics of a spacer, and has the OD value capable of reaching 4 after overlapping with the black sealant to completely solve light leakage on the lateral side. Meanwhile the BPS 6 and the spacer can be done in the same manufacturing process without additional devices and manufacturing processes. Certainly, the light Shading body 15 can also be made of other materials. The spacer 5 is positioned between an inner surface edge of the first substrate 13 and an inner surface of the second substrate 15. The spacer 5 can also be a PS, other spacers and the like

The spacer is positioned between the inner surface of the first substrate 13 and the inner surface of the second substrate 14. The spacer 5 is made from a same material as the light shading body 15. Since the spacer 5 is made from a same material as the light shading body 15, and the spacer 5 between the inner surface of the first substrate 13 and the inner surface of the second substrate 14 also is the BPS 6, the spacer 5 between the inner surface of the first substrate 13 and the inner surface of the second substrate 14 as well as the light shading body 15 between the inner surface edge of the first substrate 13 and the inner surface edge of the second substrate 14 can be arranged in the same process without additional devices and manufacturing processes.

As shown in FIG. 5 to FIG. 8, the display module 10 in embodiments of FIG. 5 to FIG. 8 includes a display panel 11 and a nodule frame 8. A lateral side of the display panel 11 is connected to the module frame 8 through use of a light shading adhesive body 4. The lateral side of the display panel 11 is connected to the periphery of the module frame 8 through use of the light shading adhesive body 4 to prevent the lateral side of the display panel 11 from leaking light. The light shading adhesive body 4 has good viscosity, can, firmly adhere two different media such as the module frame 8 and the display panel 11 on both sides, is resistant to environmental changes, is not easy to generate bubbles, can be controlled in thickness by adjusting the amount of sealant, and is especially suitable for the four-sided borderless display panel 11.

A light shading body 15 is positioned between an inner surface edge of the first substrate 13 and an inner surface edge of the second substrate 14. The light shading body 15 is connected to the light shading adhesive body 4. The black sealant has an OD value capable of reaching 2 in the case of 3 μm due to consideration of sealing performance, and cannot meet the requirement of completely shading light rays (OD≥4). A circle of light shading body 15 is positioned between the inner surface edge of the first substrate 13 and the inner surface edge of the second substrate 14. namely; around the display panel 11. The light shading body 15 is connected to the black sealant. The OD value after the light shading body 15 is overlapped with the black sealant reaches 4 to completely solve light leakage on the lateral side.

A black matrix (BM) 7 is disposed on an outer surface edge of the second substrate 14. The light shading body 15 is arranged in correspondence with the BM 7. In a four-sided borderless display panel 11, especially TFT-LCD products, since glass on the TFT side faces forwards, a front side may shield surrounding metal wires through a manufacturing process of printing the BM 7 to avoid visual user interference. The light shading body 15 is arranged in correspondence with the BM 7 so that the surrounding metal wires and the light leakage on the lateral side can be shielded through coordination of the light shading body 15 and the BM 7.

As shown in FIG. 8, the display module 10 in an embodiment of FIG. 8 includes a display panel 11 and a module frame 8. A lateral side of the display panel 11 is connected to the module frame 8 through use of a black sealant. The display panel 11 includes a first substrate13 and a second substrate 14 arranged opposite to each other. An outer, surface edge of the first substrate 13 is connected to the module frame 8 through use of the black sealant. A BPS 6 is positioned between an inner surface edge of the first substrate 13 and an inner surface edge of the second substrate 14. The BPS 6 is connected to the black sealant. A BM 7 is disposed on an outer surface edge of the second substrate 14. The BPS 6 is arranged in correspondence with the BM 7. A spacer 5 is positioned between an inner surface of the first substrate 13 and an inner surface of the second substrate 14. The spacer 5 is made from a same material as the BPS 6. The display panel 11 is connected to the module frame through use of the black sealant. The black sealant has advantages of good viscosity and resistance to environmental changes, and can be controlled in thickness by adjusting the amount of sealant. The existing black sealant has an OD value capable of only reaching about 2 in the case of 3 μm due to consideration of sealing performance, and cannot meet the requirement of completely shading light rays (OD≥4). A circle of BPS 6 is arranged around the display panel 11. The BPS 6 has the OD value capable of only reaching about 2 dues to consideration of characteristics of the spacer 5. The OD value can reach or exceed 4 after the black sealant is overlapped with the BPS 6, to perfectly solve light leakage on the lateral side. The surrounding BPS 6 can be done in a PS manufacturing process without adding other manufacturing processes, thereby improving production efficiency and reducing costs. The BPS 6 is arranged in correspondence with the BM 7, and the BM 7 and the BPS 6 have approximate or equivalent width, so as to better shield light rays. The spacer 5 may be a PS, other spacers and the like.

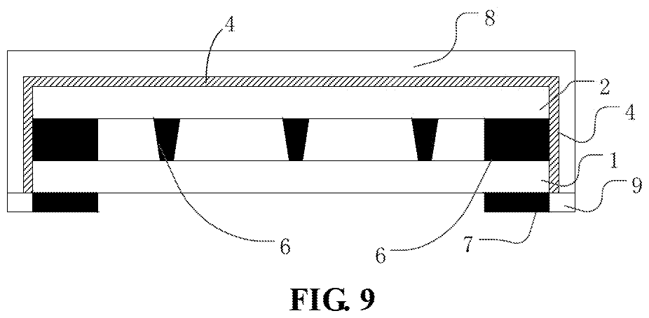

As shown in FIG. 9, the display module 10 in an embodiment of FIG. 9 includes a display panel 11 and a module frame 8. A lateral side of the display panel 11 is connected to the module frame 8 through use of a black sealant. The display panel 11 includes a first substrate 13 and a second substrate 14 arranged opposite to each other. An outer surface edge of the first substrate 13 is connected to the module frame 8 through use of the black sealant. A BPS 6 is positioned between an inner surface edge of the first substrate 13 and an inner surface edge of the second substrate 14. The BPS 6 is connected to the black sealant. A BM 7 is disposed on an outer surface edge of the second substrate 14. The BPS 6 is arranged in correspondence with the BM 7. A spacer 5 is positioned between an inner surface of the first substrate 13 and an inner surface of the second substrate 14. The spacer 5 is made from a same material as the BPS 6. The display panel 11 is connected to the module frame 8 through use of the black sealant. The black sealant has advantages of good viscosity and resistance to environmental changes, and can be controlled in thickness by adjusting the amount of sealant. The existing black sealant has an OD value capable of only reaching about 2 in the case of 3 μm due to consideration of sealing performance, and cannot meet the requirement of completely shading light rays (OD≥4). A circle of BPS 6 is arranged around the display panel 11. The BPS 6 has the OD value capable of only reaching about 2 dues to consideration of characteristics of the spacer 5. The OD value can reach or exceed 4 after the black sealant is overlapped with the BPS 6, to perfectly solve light leakage on the lateral side. The surrounding BPS 6 can be completed in a PS manufacturing process without adding other manufacturing processes, thereby improving production efficiency and reducing costs. The spacer 5 is positioned between the first substrate 13 and the second substrate 14. The spacer 5 can be a PS, a BPS, other spacers, and the like.

The BM 7 is disposed on the outer surface edge of the second substrate 14. The light shading body 15 is arranged in correspondence with the BM 7. In a four-sided borderless display panel 11, especially TFT-LCD products, since glass on the TFT side faces forwards, a front side may shield surrounding metal wires through a manufacturing process of printing the BM 7 to avoid seal user interference. The light shading body 15 is arranged in correspondence with the BM so that the surrounding metal wires and the light leakage on the lateral side can be shielded through coordination of the light shading body and the BM 7.

A light shielding body 9 is disposed on the lateral side of the BM 7. The light shielding body 9 is connected to the light shading adhesive body 4 and/or the module frame 8. In the four-sided borderless display panel 11, especially the TFT-LCD products, since the glass on the TFT side faces forwards, the front side may shield the surrounding metal wires through a manufacturing process of printing the BM 7. The lateral side of the display panel is connected t the module frame 8 via the light shading adhesive body 4. An outer side of the BM 7 is further connected to the light shading adhesive body 4 midi or the module frame 8 via the light shielding body 9 to further prevent the lateral side from leaking light. The light shielding body 9 may be the black sealant, a black tape, and the like, and may also be made from a same material as the BPS, the BM 7, and the like.

In an embodiment of the present application, the present embodiment discloses a display apparatus 20. The display apparatus 20 includes a housing 21. A backlight module 22, a display module 10 and a control circuit board 12 are arranged in the housing. The display module 10 includes a display panel 11 and a module frame 8. The backlight module 22 provides a light source. The control circuit board 12 provides a display signal to the display panel 11. The display module 10 is the display panel 11 in the above embodiments, a specific structure and a connection relationship with respect to the display module 10 can be seen in FIG. 1 to FIG. 9, and are no longer detailed herein.

In the above embodiments, the first substrate 13 and the second substrate 14 are arranged opposite to each other. Liquid crystals are positioned between the first substrate 13 and the second substrate 14. Inner surfaces of the first substrate 13 and the second substrate 14 face the liquid crystals. Outer surfaces of the first substrate 13 acid the second substrate 14 are back to the liquid crystals. In the above embodiments, the display module 10 includes the display panel 11. The display panel 11 includes a liquid crystal panel, a plasma panel, and the like. The liquid crystal panel, taken as an example, includes a TFT substrate 1 and a color filter (CF) substrate 2. The LET substrate 1 and the CF substrate 2 are arranged opposite to each other. The liquid crystals and the PS are positioned between the TFT substrate 1 and the CF substrate 2. A TFT is disposed on the TFT substrate 1. A color filter layer is disposed on the CF substrate 2. The PS can also be the BPS 6. In the above embodiments, the CF substrate 2 may include a TFT array. A color filter and the array may be formed on the same substrate. In the above embodiments, the display panel 11 of the present application may be a curved panel. In the above embodiments, the module frame 8 is a module iron frame and can also be a frame made of other materials, such as a module plastic frame, a module steel frame, and the like. The first substrate 13 may be the TFT substrate 1 or the CF substrate 2. The second substrate 14 correspondingly may be the CF substrate 2 or the TFT substrate 1. The first substrate 13 and the second substrate 14 may be made of glass, plastics, and the like.

The above contents are detailed descriptions of the present application in combination with specific embodiments. However, the concrete implementation of the present application shall not be considered to be only limited to these descriptions. For those ordinary skilled in the art to which the present application belongs, several simple deductions or replacements pray be made without departing from the conception of the present application, all of which shall be considered to belong to the protection scope of the present application.

What is claimed is:

1. A display module, comprising:
a display panel; and
a module frame;
wherein a lateral side of the display panel is connected to the module frame through use of a light shading adhesive body;
wherein the display module is coupled to a control circuit board;
wherein the display panel comprises a first substrate and a second substrate arranged opposite to each other; and an outer surface edge of the first substrate is connected to the module frame through use of a light shading adhesive body; and the light shading adhesive body is a black sealant;
wherein a light shading body is positioned between an inner surface edge of the first substrate and an inner surface edge of the second substrate; and the light shading body is connected to the black sealant; and the light shading body is a black photoresistance spacer (BPS);
wherein a spacer is positioned between an inner surface of the first substrate and an inner surface of the second substrate; and the spacer is made from a same material as the light shading body,
wherein a black matrix (BM) is disposed of an outer surface edge of the second substrate; and the light shading body is arranged in correspondence with the BM.

2. A display module, comprising:
a display panel; and
a module frame, wherein a lateral side of the display panel is connected to the module frame through use of a light shading adhesive body.

3. The display module according to claim 2, wherein the display panel comprises a first substrate and a second substrate arranged opposite to each other; and an outer surface edge of the first substrate is connected to the module frame through use of a light shading adhesive body.

4. The display module according to claim 2, wherein the light shading adhesive body is a black sealant.

5. The display module according to claim 4, wherein a shading body is positioned between an inner surface edge of the first substrate and an inner surface edge of the second substrate; and the light shading body is connected to the black sealant.

6. The display module according to claim 5, wherein the light shading a black photoresistance spacer (BPS).

7. The display module according to claim 5, wherein a spacer is positioned between an inner surface of the first substrate and an inner surface of the second substrate; and the spacer is made from a same material as the light shading body

8. The display module according to claim 5, wherein a black matrix (BM) is disposed on the outer surface edge of the second substrate; and the light shading body is arranged in correspondence with the BM.

9. The display module according to claim 8, wherein the light shading body is disposed on a side of the black matrix (BM); and the light shading body is connected to the light shading adhesive body and/or the module frame.

10. The display module according to claim 3, wherein the light shading adhesive body is the black sealant.

11. The display module according to claim 10, wherein the light shading body is positioned between the inner surface edge of the first substrate and an inner surface edge of the second substrate; and the light shading body is connected to the black sealant.

12. The display module according to claim 11, wherein the light shading body is the black photoresistance spacer (BPS).

13. The display module according to claim 11, wherein the spacer is positioned between the inner surface of the first substrate and the inner surface of the second substrate; and the spacer is made from a same material as the light shading body.

14. The display module according to claim 11, wherein the black matrix (BM) is disposed on the outer surface edge of the second substrate; and the light shading body is arranged in correspondence with the BM.

15. The display module according to claim 14, wherein the light shading body is disposed on the lateral side of the black matrix (BM): and the light shading body is connected to the light shading adhesive body and/or the module frame.

16. The display module according to claim 3, wherein the light shading adhesive body is the black sealant; and the black photoresistance spacer (BPS) is positioned between the inner surface edge of the first substrate and the inner surface edge of the second substrate; and the black photoresistance spacer (BPS) is connected to the black sealant;
wherein the black matrix (BM) is disposed on the outer surface edge of the second substrate; and the BPS is arranged in correspondence with the black matrix:
the spacer is positioned between the inner surface of the first substrate and the inner surface of the second substrate; and the spacer is made from the same material as the BPS.

17. A display apparatus, comprising:
a display module; and
a control circuit board;
wherein the display module comprises a display panel and a module frame; and a lateral side of the display panel is connected to the module frame through use of a light shading adhesive body; and the display module is coupled to the control circuit board.

18. The display apparatus according to claim 17, wherein the light shading adhesive body is a black sealant, and a light shading body is positioned between an inner surface edge of the first substrate and an inner surface edge of the second substrate; and the light shading body is connected to the black sealant; acid the light shading body is a black photoresistance spacer;
wherein a spacer is positioned between an inner surface of the first substrate and an inner surface of the second substrate; and the spacer is made from a same material as the light shading body;
wherein a black matrix (BM) is disposed on an outer surface edge of the second substrate; and the light shading body is arranged in correspondence with the BM.

19. The display apparatus according to claim 17, wherein the display panel comprises a first substrate and a second substrate arranged opposite to each other; and an outer surface edge of the first substrate is connected to the module frame through use of the light shading adhesive body.

20. The display apparatus according to claim 19, wherein the light shading adhesive body is the black sealant; and the light shading body is positioned between the inner surface edge of the first substrate and the inner surface edge of the second substrate; and the light shading body is connected to the black sealant; and the light shading body is the black photoresistance spacer (BPS);
wherein the spacer is positioned between the inner surface of the first substrate and the inner surface of the second substrate; and the spacer is made from a same material as the light shading body;
wherein the black matrix (BM) is disposed on the outer surface edge of the second substrate; and the light shading body is arranged in correspondence with the BM.
